(19) United States
(12) Patent Application Publication
(10) Pub. No.: US 2021/0255618 A1
(43) Pub. Date: Aug. 19, 2021

(54) Scalable Remote Operation of Autonomous Robots

(71) Applicant: Bayerische Motoren Werke Aktiengesellschaft, Muenchen (DE)

(72) Inventors: Dennis LENZ, Muenchen (DE); Dominik RIETH, Muenchen (DE); Roland WILHELM, Muenchen (DE)

(21) Appl. No.: 17/269,853

(22) PCT Filed: Jul. 29, 2019
(86) PCT No.: PCT/EP2019/070355

§ 371 Date: Feb. 19, 2021

(30) Foreign Application Priority Data
Aug. 20, 2018 (DE) 10 2018 214 023.5

(51) Int. Cl. G05D 1/00

(52) U.S. Cl. CPC G05D 1/0027; G05D 2201/0213; G05D 1/0061; G05D 1/0038

(57) ABSTRACT

A robot of a plurality of robots is remotely operated. The state of the robot is determined. A first desired state of the robot is determined. First control data are generated to transfer the robot into the first desired state. The robot is controlled based on the first control data. Actual operating data is transmitted to a server. Second control data is received from the server. The control data transfers the robot into a second desired state. The robot is autonomously controlled based on the second control data. The robot may include a controller that communicates with a server.

### BACKGROUND AND SUMMARY OF THE INVENTION

The present disclosure relates to systems and methods for the teleoperation of autonomous robots. The disclosure relates in particular to scalable intelligent systems and methods for the teleoperation of autonomous robots in critical situations. The systems and methods relate in particular to automated vehicles.

Teleoperation of autonomous robots is known in the prior art. It is assumed that the robot performs its tasks basically autonomously and self-sufficiently, and that an intervention into the control is necessary only in particular situations. The robots are respectively equipped, inter alia, with sensors, actuators, and one or several computers. The computers are designed to plan the completion of the respectively assigned tasks or the achievement of predetermined objectives, and to adjust operation of the robot under certain conditions.

The term “autonomous robot” generally relates to stationary and mobile robots which are configured for automated and/or autonomous operation. In particular, the present disclosure relates to automated vehicles which are capable of automated driving, essentially without manual intervention. Within the scope of the document, the term “automated driving” may be understood to mean driving using automated longitudinal or lateral guidance, or automated driving using automated longitudinal and lateral guidance. The automated driving may, for example, comprise temporally extended driving on the motorway or temporally limited driving within the scope of parking or maneuvering. The term “automated driving” comprises automated driving having any arbitrary level of automation. Examples of levels of automation include assisted, partially automated, highly automated, or fully automated driving. These levels of automation have been defined by the German Federal Highway Research Institute (BASt) (see BASt publication “Forschung kompakt,” edition November 2012). In assisted driving, the driver continuously performs the longitudinal or lateral guidance, while the system assumes the respective other function within certain limits. In partially automated driving (PAD), the system assumes the longitudinal and lateral guidance for a certain period of time and/or in specific situations, wherein the driver must monitor the system continuously, as in assisted driving. In highly automated driving (HAD), the system assumes the longitudinal and lateral guidance for a certain period of time, without the driving having to monitor the system continuously; however, the driver must be capable of assuming the guidance of the vehicle within a certain period of time. In fully automated driving (FAD), the system can automatically handle the driving in all situations for a specific application case; a driver is no longer needed for this application case. The aforementioned automation levels correspond to SAE Levels 1 to 4 of the SAE (Society of Automotive Engineering) J3016 standard. For example, highly automated driving (HAD) corresponds to Level 3 of the SAE J3016 standard. Furthermore, SAE Level 5 is designated as the highest automation level in SAE J3016, but is not included in the definition of the BASt. SAE Level 5 corresponds to driverless driving, in which the system is able to handle all situations automatically like a human driver during the entire trip; a driver is generally no longer necessary. The present disclosure relates in particular to highly automated or fully automated driving.

During the autonomous operation of a robot, situations may occur in which, using the locally available resources, the robot is no longer able to determine operating parameters which would ensure continued safe autonomous operation. In such situations, an autonomous robot typically discontinues operation completely, establishes a safe state as necessary, and is subsequently dependent on external, manual intervention. Corresponding critical situations for autonomous robots may include, for example, an object entering the path of motion or operation of the robot, in which the robot is not able to determine a way to avoid the object. Technical disturbances, for example, in the sensor system and/or the actuator system of the robot, can also have a similar effect and can impair further safe operation or make it impossible. In the described situations and similar critical situations, the autonomous robot typically discontinues operation and waits for an external manual intervention. Such an intervention may include direct manual control or additional interventions, for example, handling the surroundings of the robot (for example, removing the object).

Automated vehicles are typically subjected to highly complex operating conditions. In some cases, the surroundings of an automated vehicle comprise highly dynamic elements, for example, other road users who do not always act rationally, dynamic traffic routing, traffic light systems having changing signals, and much more.

Situations which may become problematic for an automated vehicle comprise, for example, changes in the traffic routing. These changes can occur, for example, in the vicinity of roadworks, which may comprise modified traffic routing, a reduction in the number of road lanes, deviations from map data, detours, and the like. Furthermore, these changes may occur in the case of accidents (for example, blockages, detours, alternating traffic control at the accident site), or in the case of the failure of signaling systems, if the police direct traffic manually. In addition, everyday situations can have similar effects on automated vehicles, for example, in the case of delivery vehicles which are double-parked and which at least partially block the roadway.

While the aforementioned situations are relatively easily recognizable to a human driver and can usually be handled without problems, they frequently push automated vehicles to their limits.

As a result, during the operation of automated vehicles, on the one hand, it must be ensured that the driving operation of the vehicles does not create hazardous situations, but on the other hand, if problematic situations arise, it must also be ensured that the driving operation is not simply discontinued and/or that traffic routes are blocked temporarily or on a sustained basis. In addition, in the case of highly automated or fully automated vehicles, it is usually no longer possible for the vehicle user to intervene locally into the control of the vehicle, either because the relevant operating elements are malfunctioning, or because the vehicle users do not have the capability or permission to control a vehicle.

The publication DE 10 2016 213 300 describes a method for driving an autonomously driving vehicle. The method is carried out in the vehicle and comprises the determination, on the basis of sensor data relating to the surroundings of the vehicle, that a critical driving situation is imminent, in which the vehicle cannot drive autonomously. In addition, the method comprises transmitting situational data with respect to the critical driving situation, and sending a handover request to a central unit which is arranged separate from the vehicle. The method further comprises receiving control data for driving the vehicle from the central unit, wherein the control data are a function of the situational data. Further, the method comprises driving the vehicle during the critical driving situation, as a function of the control data. The central unit may comprise a user interface which allows a person to take at least partial manual remote control of the vehicle, on the basis of the situational data. For example, by means of the central unit, a driving simulator can be provided which makes the critical driving situation comprehensible to a person at the central unit, on the basis of the situational data (for example, by displaying image data with respect to the surroundings of the vehicle). Via control means at the central unit (for example, via an accelerator pedal and/or steering wheel), the person can then generate control data via which the vehicle is remotely controlled. Thus, a human is able to control the autonomously driving vehicle remotely. Thus, in critical driving situations, it is possible for a driver who is situated outside the vehicle to drive the vehicle manually in a reliable manner. The described method assumes that the vehicle is linked to the central unit which is manually operated by the person.

The publication US 2006/089800 A1 describes a system and method for the multimodal control of a vehicle. Actuators manipulate input devices (for example, steering controllers and drive controllers, for example, a throttle valve, brake, accelerator pedal, throttle control, steering gear, tie rods, or gear shift lever), in order to control the operation of the vehicle. Behaviors which characterize the operating mode of the vehicle are linked to the actuators. After receiving a command for selecting a mode which determines the operating mode of the vehicle (for example, manned operation, remote-controlled unmanned teleoperation, assisted remote teleoperation, and autonomous unmanned operation), the actuators manipulate the operator input devices according to the behavior, in order to influence the desired operating mode. Essentially, the publication describes the operation of a vehicle in discrete operating modes, of which individual modes provide manual remote control of the vehicle by means of an operator who is external to the vehicle.

The publication US 2015/0248131 A1 describes systems and methods which make it possible for an autonomous vehicle to request help from a remote operator in particular predetermined situations. The described method comprises determining a representation of surroundings of an autonomous vehicle, based on sensor data about the surroundings. Based on the depiction, the method can also comprise the identification of a situation from a predetermined number of situations for which the autonomous vehicle requests remote assistance. Further, the method may comprise the transmission of a query for assistance to a remote assistant, wherein the query includes the depiction of the surroundings and the identified situation. The method may additionally comprise receiving a response from the remote operator which indicates autonomous operation. The method may also comprise causing the autonomous vehicle to carry out the autonomous operation.

The publication DE 10 2013 201 168 describes a remote control system for motor vehicles which is activatable as required, via a radio data communication link to a control center. According to the present subject matter, the control center is configured to convey requests for remote monitoring and/or remote control of a motor vehicle, and proposals for carrying out the remote control of the motor vehicle from personal data terminal devices situated remotely from the control center, and after accepting a proposal, to provide a data communication link between the motor vehicle and the person data terminal device from which the proposal originates. In addition, each personal data terminal device is configured to carry out the remote monitoring and/or remote control of the motor vehicle via the provided data communication link, in the manner of driving simulation computer games.

In the case of automated vehicles, it is to be assumed that as the number of automated vehicles increases, the number of operators who are immediately available and who can manually intervene into the control of an individual vehicle must also increase. This is because, in critical situations in which an automated vehicle is not able to continue to drive independently, possible waiting times are not acceptable to the user of the vehicle. Solutions based on manual interventions of human operators, as described in the prior art, have the disadvantage that they are not highly scalable and are difficult to apply to a large number of vehicles.

Furthermore, there is the possibility that a particular problematic situation has already been handled by a human operator one time or several times. In the case of a large number of human operators which is to be expected, it may be difficult to provide all operators with the same level of knowledge at any point in time, such that problematic situations which are already known can be effectively and efficiently handled. Also in this respect, known methods are not highly scalable.

Furthermore, solutions based on manual interventions by human operators as described in the prior art have the disadvantage that they are dependent on a direct and essentially latency-free link between the operator and the vehicle, since, for performing the manual interventions into the control of the vehicle which are to be carried out by the operator, the operator must receive available information about the surroundings of the vehicle (for example, via an audio/video data stream) essentially immediately, and the control commands must also return to the vehicle essentially immediately. Even relatively minor latency periods (for example, in the range of 500 milliseconds in the case of links via satellite) can have a highly negative affect on the control options. In addition, such applications place a very high demand on the bandwidth of the data links, in order, for example, to be able to provide video streams having sufficient quality and/or sufficiently detailed data about the surroundings of the vehicle.

In the case of automated vehicles, there is furthermore an important requirement that, in the event of a situation which cannot be handled by the vehicle, the vehicle must at least assume a safe state. This may, for example, comprise not standing still on a roadway or traffic lane which is used by other vehicles. Otherwise, a vehicle which requires assistance could become an obstacle for other vehicles and/or cause hazardous situations. Solutions known in the prior art possibly require the operator first being contacted and adapting to the situation before being able to begin assuming control of the vehicle. Under some circumstances, this time is not available, for example, in the case of a high volume of oncoming traffic.

Based on the aforementioned problems, there is the need for systems and methods for the teleoperation of autonomous robots which provide high scalability and which can be applied to a large number of vehicles both effectively and efficiently.

Furthermore, there is the need for systems and methods for the teleoperation of autonomous robots which can be used even with links having higher latency periods and/or lower bandwidths.

Furthermore, there is the need for systems and methods for the teleoperation of autonomous robots which enable a rapid response to problematic situations, in particular known, similar, and/or frequently occurring problematic situations.

One object of the present disclosure is to provide systems and methods for the teleoperation of autonomous robots which avoid one or several of the aforementioned disadvantages, or which achieve one or several of the aforementioned advantages.

In an embodiment of the present subject matter, a method is specified for the teleoperation of one robot of a plurality of robots. The disclosed method comprises determining an actual state of the robot, transmitting current operating data to a server based on the actual state of the robot, receiving second control data from the server which are configured to put the robot into a second setpoint state, controlling the robot based on the second control data, and controlling the robot autonomously. Optionally, the disclosed method further comprises determining a first setpoint state of the robot, generating first control data which are configured to put the robot into the first setpoint state, and controlling the robot based on the first control data, wherein the aforementioned steps are carried out preferably after the determination of an actual state of the robot and before or during the transmission of the current operating data to the server, based on the actual state the robot.

In the actual state, the robot may not be able to autonomously handle a task which has been assigned to it.

The current operating data comprises surroundings data which describe surroundings of the robot. Preferably, the current operating data comprise data which are collected over a period of time and which describe a predetermined period of time up to the occurrence of the actual state.

The disclosed method comprises generating evaluation data based on an application of the second control data, and optionally the second setpoint state, to a local model, and transmitting the evaluation data to the server. Optionally, the disclosed method further comprises again receiving second control data, wherein the control of the robot takes place based on the second control data, if the second control data have been confirmed by the server.

The disclosed method is specified for the teleoperation of one robot of a plurality of robots. The disclosed method comprises receiving current operating data of the robot by means of a server, determining a second setpoint state of the robot, generating second control data which are configured to put the robot into the second setpoint state, and transmitting the second control data to the robot.

Determining the second setpoint state of the robot comprises comparing the current operating data to predetermined operating data of a plurality of predetermined operating data. In the case of a predetermined ratio of the current operating data to the predetermined operating data of the plurality of predetermined operating data exists, the disclosed method further comprises generating the second control data based on the predetermined operating data. Otherwise, the method further comprises carrying out one or several simulations based on the current operating data, generating the second control data based on the one or several simulations, and adding the current operating data and the generated second control data as additional predetermined operating data to the plurality of predetermined operating data. The predetermined ratio preferably includes essentially matching the current operating data with the predetermined operating data of the plurality of predetermined operating data.

The disclosed method further comprises receiving evaluation data from the robot.

The system is specified for the teleoperation of a robot. The system comprises a server which is configured for carrying out the disclosed method

The system further comprises one teleoperator of a plurality of teleoperators. The steps of determining a second setpoint state of the robot and generating second control data which are configured to put the robot into the second setpoint state are carried out by the teleoperator. Optionally, the teleoperator comprises a human operator.

The robot comprises an electronic control unit which is configured for carrying out the disclosed method. Optionally, the robot comprises an automated vehicle which comprises means for the semiautonomous or autonomous control of the vehicle.

Example embodiments of the disclosure are depicted in the figures and will be described in greater detail below. In the figures, identical reference signs are used for identical and identically acting elements, unless otherwise noted below.

### BRIEF DESCRIPTION OF THE DRAWINGS

FIG. 1 depicts a block diagram of a system for the teleoperation of robots, according to embodiments of the present disclosure;

FIG. 2 depicts a flow chart of a method for the teleoperation of robots, according to embodiments of the present disclosure; and

FIG. 3 depicts a flow chart of a method for the teleoperation of robots, according to embodiments of the present disclosure.

### EMBODIMENTS OF THE DISCLOSURE

### Detailed Description of the Drawings

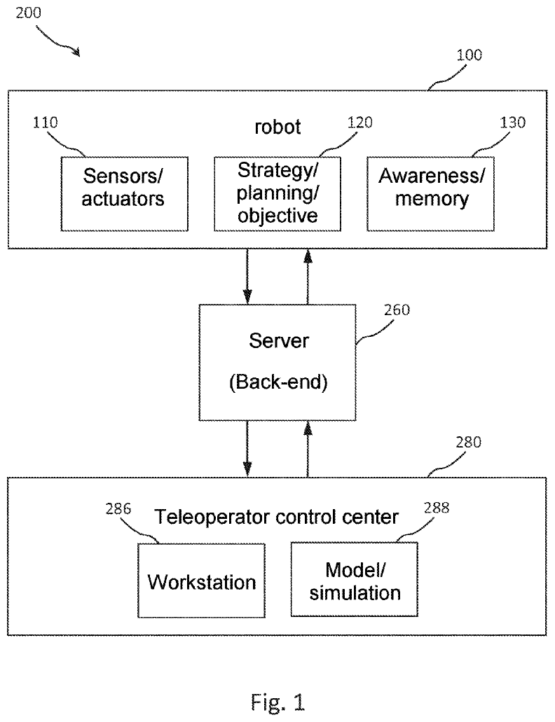

FIG. 1 depicts a block diagram of a system 200 for the teleoperation of robots 100, according to embodiments of the present disclosure. A robot 100, for example, an automated vehicle, comprises a sensor system/actuator system 110 comprising one or several sensors for detecting surroundings around the robot (for example, radar, lidar, infrared, ultrasound), and one or several actuators for operating the robot 100. Further, the robot 100 comprises an electronic control unit 130 which, inter alia, is configured to receive data from the sensor system, to process the data, and to control the actuator system based on the received data and/or the processing. Memory, communication interfaces, processors, and the like are integrated into the electronic control unit and/or connected thereto. The robot further comprises a suitable representation 120 of a superordinate strategy, one or several plans, and/or objectives, which are configured to define one or several tasks of the robot 100. In the case of an automated vehicle, the representations 120 may comprise, for example, starting points or arrival points of a navigation task and corresponding route criteria.

The robot 100 is generally capable of executing the assigned tasks independently and autonomously. In the case of an automated vehicle, the electronic control unit 130 can independently determine a suitable route and travel along the determined route to the arrival location by means of the sensor system and actuator system, based on the available data, in particular based on the representations of the starting point (for example, current position), route criteria (for example, planning, strategy), and destination (for example, arrival location). Optionally, the robot receives additional data from the server (for example, back-end), for example, current traffic data or other dynamic data which normally cannot be provided in a local database (cf. map data available in the vehicle).

The robot 100 is optionally in data communication with a server 260 and/or a teleoperator control center 280 via a communication interface (not depicted). If needed, the data connection can be established if data are to be transmitted from the robot 100 to the server 260 or to the teleoperator control center 280, or vice-versa.

An “awareness function” or a “watchdog” which is implemented in the electronic control unit 130 monitors all necessary subsystems (for example, the sensor system, the actuator system) of the robot 100. This function is used to detect anomalies, system limits, sensor discrepancies, and other events which may result in the robot 100 no longer being able to react autonomously or no longer being able to make an optimal decision independently. In the case of an automated vehicle, such situations may, for example, result in modified traffic routing due to a construction site not recorded in the map material, manual control of the traffic via hand signals made by the traffic police, or behavior of one or several road users which is inconclusive or difficult to interpret (for example, double-parking, hazard lights, etc.; as described above).

In such cases, a trigger is initiated by the electronic control unit 130, which is transmitted to the server 260. This trigger ensures that the robot 100, of which the electronic control unit 130 has determined the problem, is linked to a teleoperator from the control center 280. Depending on the priority, the difficulty of the problem, etc., an operator is selected by the server 260, who is notified of the case at the operator's workstation 286. If the operator takes this case, all information from the sensor systems and actuator systems 110, and the current status of all additional functions (for example, robot data, operating parameters, position), are transmitted from the robot 100 to the operator, if this information can be helpful for resolving the situation. This information optionally comprises a certain period of time before the occurrence of the situation up to its occurrence, so that, on the basis thereof, conclusions can be drawn about the origin, causes, and other influencing factors. In the case of an automated vehicle, for example, such information may, in particular comprise known traffic signs, driver behavior, and/or the position of other road users, operating parameters of the vehicle and its trajectory, and the like.

Depending on the situation/problem, the amount of data which must be transmitted to the teleoperator control center may become relatively extensive, for example, in the range from several hundred kilobytes (for example, one or several still images and known objects) to many gigabytes (for example, in addition, high-resolution video streams from one or several cameras), in order to allow the operator to be able to work out a solution. The transmission of the data from the robot to the server or to the teleoperator control center takes place by means of suitable data transmission means. In the case of a large number of autonomously acting robots, the problems/situations can typically be assumed to occur sporadically. The concepts according to embodiments of the present disclosure therefore allow a small number of operators to oversee a large number of robots 100.

In order to be independent of a low level of transmission latency of the information, the systems 200 and methods 300 are designed in such a way that the operator can act indirectly. Therefore, a direct, bidirectional link having low latency for controlling the robot 100 (i.e., real-time control) is not required by an operator. One precondition for this is that the robot assumes a “safe state” in situations or states which cannot be handled by it autonomously, such that real-time control is not required. For this purpose, the robot 100 first determines the occurrence of a situation in which it can no longer act autonomously in order to handle its task, wherein, starting from an actual state, the robot subsequently generates a setpoint state (=“safe state”), and enters this state. In the case of an automated vehicle, an example situation would correspond to modified traffic routing caused by a construction site, and a safe state would correspond, for example, to stopping on an emergency lane and activating the hazard warning lights. In this case, stopping on the roadway is to be avoided, and a safe (parking) position is to be assumed at least temporarily.

In such a situation, the robot transmits its current operating state to the server 260, the data of which the operator can access. The current operating state may comprise a plurality of parameters and information, for example, the exact operating parameters of the robot (for example, type, state, drive parameters, position, orientation, audio/video information, data of the sensor system/actuator system, and the like). Furthermore, the actual state and the safe state (i.e., the first setpoint state) can be included in the current operating parameters, just like the task of the robot 100 (which is actually to be fulfilled autonomously, in the case of a vehicle, for example, a target destination to be reached and route criteria). In addition, the current operating data are collected over a predetermined period of time (for example, up to 30 seconds) before the occurrence of the situation or the problem (i.e., up to the occurrence of the actual state and possibly up to the occurrence of the first setpoint state or “safe state”), in order to be able to form a conclusion about how the situation or the problem or the actual state has occurred.

The operator can then first check whether a similar situation or a similar problem has already occurred, and whether a corresponding solution exists. In the case of a large number of robots 100, it can be assumed that only a few problems or situations are really new and require a new solution. Usually, the problem or the situation is likely to be known, and a solution is already available (for example, stored on the server 260). This can take place based on the transmitted current operating data of the robot 100. If a solution is already available (for example, in the form of control data and a second setpoint state which is to be achieved, which can be achieved based on the control data), the solution can be immediately transmitted to the robot 100 in the form of control data. The robot 100 then executes the transmitted control data and, if necessary, again goes into autonomous operation. The problem has been handled, and the operator is available for queries of other robots 100.

If no solution is yet known for the situation or the problem, the operator can carry out one or several simulations based on the transmitted current operating data, wherein a local model can depict the problem and generate further approaches and possible solutions, based on all information available from the past, up to the occurrence of the situation. The operator is correspondingly trained and has a comprehensive understanding of the overall robot system. Therefore, for resolving the situations, the operator can temporarily adjust objectives or the strategy, or change, override, or add rules, in order to ensure that the robot can subsequently again follow its original objectives self-sufficiently and autonomously. In the case of an automated vehicle, the operator can, for example, allow the vehicle to drive over solid lines (which does not typically take place), or to ignore traffic signs or light signals. The vehicle can thus also follow a modified traffic lane course if contradictory roadway markings are present, or ignore a traffic light system if a traffic police agent is manually directing traffic at an intersection.

If the operator has worked out such a solution which functions in the operator's local simulation, there is also the possibility to request feedback from the robot 100 one or several times. This may be necessary, since a model is possibly used locally (i.e., in the teleoperator control center) which is simpler than the model implemented in the robot 100. For this purpose, the solution is transmitted via the server to the robot without approval for execution, and the results of the prediction, planning, and strategy are transmitted back as feedback. If the operator receives an indication that a valid solution has been found, the operator can approve the execution. Otherwise, the recommended solution is corrected locally and adjusted until a satisfactory result has been found. Subsequently, the approval is once again given for the solution, which is transmitted to the robot 100 in the form of control data.

The robot executes the solution which was approved for it, and subsequently goes again into its autonomous mode, which executes tasks or heads for destinations without remote access. During execution, a memory which is present in the robot 100 further records relevant information, which can be sent to the operator for evaluation. The transmission of this evaluation information is not time-critical/latency-critical. If the operator determines that the solution has actually resulted in a desired result, the operator can provide this solution in the server/back-end to all robots 100 or to those having the appropriate characteristics. Should another robot 100 encounter a similar or identical situation, or have a similar or identical problem, and request assistance as described, a solution which has already been validated (i.e., which is known to be successful and has in particular been evaluated as such) can potentially be provided immediately. This also results in fewer operators being required for many robots 100, since known solutions can be transmitted promptly or in real time (i.e., essentially without time delay) to the corresponding robot 100. Alternatively or in addition, based on a task which is assigned to it, a robot can request solutions which are already likely to be eligible, in a proactive manner, i.e., before the occurrence of the situation or the problem, in the form of control data, and have the solution ready in case the situation or problem occurs. In the case of an automated vehicle, for example, based on a generated route, the server can be checked for possibly existing exceptional situations (for example, construction sites, traffic disturbances) which potentially require the assistance of an operator. Thus, possibly existing solutions can be requested and transmitted in the form of control data before reaching the exceptional situation, such that the solutions are available in the vehicle in the event of the occurrence of the exceptional situation. Alternatively or in addition, an approved solution can be distributed by the server to all robots 100, such that, ideally, the solution does not require any problem in order to be determined in the robot 100, and the robot can complete its tasks or achieve its objectives without having to go into a “safe state” and without interruption.

A further task of the server comprises ensuring data security based on current encryption, authentication, authorization, data transmission, and data storage standards. All transmitted or stored data are thereby protected from unauthorized access. No unauthorized person is able to control a robot 100, and no unauthorized robot can request assistance from the server 260.

Overall, systems and methods according to the present disclosure minimize the data transmission quantities required for developing solutions, thus resulting, inter alia, by means of the safe state and the indirect control, in the latency of the remaining information exchange between the robot 100 and the operator being non-critical. In addition, the measures are described which allow a high level of scalability. Thus, if necessary, it is possible for a few operators to control many robots.

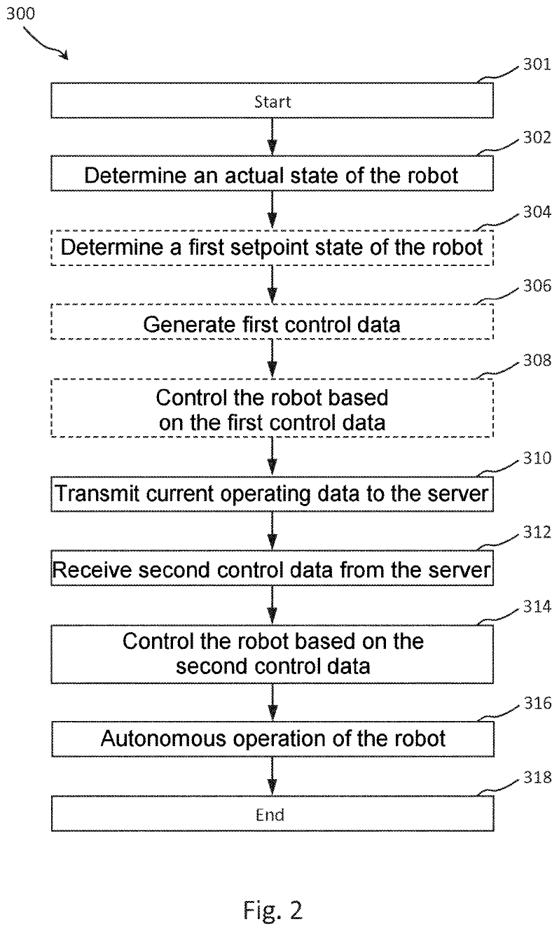

FIG. 2 depicts a flow diagram of a method 300 for the teleoperation of robots 100, according to embodiments of the present disclosure. The method 300 illustrates method steps which pertain essentially to the robot.

The method 300 begins at step 301. In step 302, an actual state of the robot 100 is determined. This actual state corresponds to a state which the robot 100 is not able to handle autonomously, but rather, for which the robot requires assistance to handle the task which has been assigned to it. First, in step 304, the robot 100 determines a first setpoint state (“safe state”) in which the autonomous operation can be discontinued without risk. In the case of vehicle, the vehicle will preferably leave the roadway and, for example, search for an emergency lane or a parking place. For a robot 100, corresponding states (for example, settings, positions) are to be prepared. In step 306, first control data are generated which are configured to put the robot into the first setpoint state. In step 308, control of the robot 100 takes place based on the first control data, in order to put the robot into the first setpoint state (“safe state”). Steps 304 to 308 are optional to the extent that the robot could possibly already be in a “safe position,” or in the case that no safe or alternative position can be assumed (for example, due to structural elements or other robots or vehicles). In such situations or similar situations, steps 304 to 308 can be omitted. In step 310, current operating data are transmitted to a server 260. The current operating data (see above) include all necessary information for finding a solution. In step 312, second control data are received from the server 260, which are configured to put the robot 100 into a second setpoint state, wherein the second setpoint state is configured to allow autonomous operation of the robot again, in which the problem is solved or the situation is handled. In step 314, the control of the robot 100 then takes place based on the second control data. Then, in step 316, the autonomous control of the robot 100 takes place. The method 300 ends at step 318.

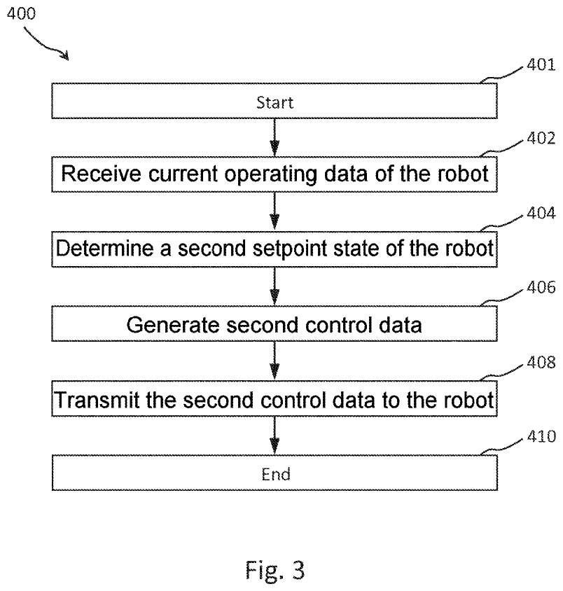

FIG. 3 depicts a flow diagram of a method 400 for the teleoperation of robots 100, according to embodiments of the present disclosure. The method 400 illustrates method steps which essentially pertain to the server.

The method 400 begins at step 401. In step 402, the server 260 receives current operating data of the robot 100. The current operating data include all information necessary for finding a solution, as described above. In step 404, a second setpoint state of the robot 100 is determined. The second setpoint state is configured to allow autonomous operation of the robot again after the problem has been resolved. In step 406, second control data are generated which are configured to put the robot 100 into the second setpoint state. In step 408, the second control data are transmitted to the robot. The method 400 ends at step 410.

The vehicle 100 preferably comprises an electronic control unit 130 which is configured for carrying out the method 300 according to the present disclosure. In a further aspect, the present disclosure comprises an electronic control unit 130, comprising a corresponding computer program for the electronic control unit.

The present disclosure further comprises a computer program, in particular a non-transitory computer program product comprising the computer program, wherein the computer program is configured to carry out at least a portion of the method according to the present disclosure, or an advantageous embodiment of the method according to one or several features of the method, on a data processing device of the vehicle (for example, electronic control unit 130) or a mobile user device. In particular, the computer program is a software program which, for example, is executable as an application (i.e., application program, for example, “app” or “application”) on an electronic control unit 130 which is installed in the vehicle or which is portable. A portion of the electronic control unit can be a mobile user device, or the electronic control unit can be in data communication with a mobile user device, in particular for the (distributed) execution of the application. The computer program comprises executable program code which executes at least a portion of the method when executed by means of a data processing device.

The non-transitory computer program product can be configured as an update of a previous computer program which, for example, comprises the portions of the computer program or the corresponding program code for a corresponding electronic control unit of the vehicle, within the scope of a functional enhancement, for example, within the scope of a so-called remote software update.

Presently, a vehicle may preferably be understood to be a single-track or multitrack motor vehicle (for example, passenger vehicle, truck, transporter, motorcycle). Several advantages which are described explicitly within the scope of this document thereby result, as well as several further advantages which are comprehensible to those skilled in the art. A particularly great advantage is possible in the case of use on a highly automated or fully automated vehicle. Alternatively, the vehicle can be an aircraft or a watercraft, wherein the method is applied to aircraft or watercraft in an analogous manner.

Although the present disclosure has been illustrated and described in detail by means of preferred example embodiments, the present disclosure is not limited by the disclosed examples, and other variations may be derived therefrom by those skilled in the art without departing from the scope of protection of the present disclosure. It is therefore obvious that a plurality of possible variations exists. It is also obvious that embodiments mentioned by way of example constitute only examples, which are not to be understood in any way to be a limitation of the scope, potential applications, or the configuration of the present disclosure. Rather, the preceding description and the description of the figures enable those skilled in the art to implement the example embodiments in a specific manner, wherein those skilled in the art, having knowledge of the disclosed idea of the present disclosure, may carry out manifold changes, for example, with respect to the function or the arrangement of individual elements mentioned in an example embodiment, without departing from the protective scope which is defined by means of the claims and the legal equivalences thereof, for example, more extensive explanations in the description.

1.-10. (canceled)

11. A method for the teleoperation of a robot of a plurality of robots, the method comprising:
determining a state of the robot;
transmitting current operating data to a server based on the state of the robot;
receiving second control data from the server to put the robot into a second setpoint state;
controlling the robot based on the second control data; and
controlling the robot autonomously.

12. The method according to claim 11, further comprising:
determining a first setpoint state of the robot;
generating first control data to put the robot into the first setpoint state; and
controlling the robot based on the first control data.

13. The method according to claim 11, wherein
in the state, the robot is not autonomously able to handle a task which has been assigned to it; or
the current operating data comprise surroundings data that describes surroundings of the robot, wherein
the current operating data comprise data which are collected over a period of time and which describe a predetermined period of time up to the occurrence of the state.

14. The method according to claim 11, further comprising:
generating evaluation data based on an application of the second control data or the second setpoint state to a local model; and
transmitting the evaluation data to the server; or
receiving second control data, wherein
the control of the robot takes place based on the second control data if the second control data have been confirmed by the server.

15. A method for the teleoperation of a robot of a plurality of robots, the method comprising:
receiving current operating data of the robot via a server;
determining a second setpoint state of the robot;
generating second control data to put the robot into the second setpoint state; and
transmitting the second control data to the robot.

16. The method according to claim 15, wherein determining the second setpoint state of the robot comprises:
comparing the current operating data to predetermined operating data out of a plurality of predetermined operating data; and
when a predetermined ratio of the current operating data to the predetermined operating data of the plurality of predetermined operating data exists:
generating the second control data based on the predetermined operating data;
otherwise:
carrying out one or several simulations based on the current operating data;
generating the second control data based on the one or several simulations; and
adding the current operating data and the generated second control data as additional predetermined operating data to the plurality of predetermined operating data.

17. The method according to claim 15, further comprising:
receiving evaluation data from the robot.

18. A system for the teleoperation of a robot, comprising:
a server to carry out the method of claim 15.

19. The system according to claim 18, wherein
the steps of determining a second setpoint state of the robot and generating second control data to put the robot into the second setpoint state are carried out by a human teleoperator.

20. A robot, comprising:
an electronic control unit to carry out the method according to claim 11; and
an automated vehicle configured to be controlled semiautonomously or autonomously.
